(19) United States
(12) Patent Application Publication
(10) Pub. No.: US 2023/0105772 A1
(43) Pub. Date: Apr. 6, 2023

(54) GRASPER FOR HOOF TRIMMING

(71) Applicants: David Hoerning, Appleton, WI (US); Bryant Hess, Shiocton, WI (US); Craig Hess, Hortonville, WI (US)

(72) Inventors: David Hoerning, Appleton, WI (US); Bryant Hess, Shiocton, WI (US); Craig Hess, Hortonville, WI (US)

(73) Assignee: Appleton Steel, Appleton, WI (US)

(21) Appl. No.: 17/721,289

(22) Filed: Apr. 14, 2022

Related U.S. Application Data
(60) Provisional application No. 63/248,426, filed on Sep. 24, 2021.

(51) Int. Cl. A01L 15/00; A01K 15/04

(52) U.S. Cl. CPC A01L 15/00; A01K 15/04

(57) ABSTRACT

An animal trimming chute for trimming the hooves animals is described which comprises at least one movable grasper adapted to secure the lower leg of an animal during hoof trimming. The grasper comprises a knee board that cooperates with two movable stages for securing the lower leg, an upper stage and a lower stage. The upper stage may have a length along the lower leg of the animal that is substantially greater than the length of the lower stage in the same direction. The animal trimming chute may be part of a smart hoof trimming system employing data from various sensors to assist a trimmer in providing improved care of animals. In one aspect, such care may require adjusting the position of the leg during treatment by releasing the lower stage while still securing the leg with the upper stage.

### BACKGROUND

### CLAIM TO PRIORITY

This application claims priority to U.S. Pat. Appl. Serial No. 63/248,426, filed Oct. 2, 2021.

### FIELD OF THE INVENTION

This invention pertains to devices for restraining animals for hoof trimming and associated methods and systems.

### BACKGROUND

Hooved animals such as cattle, bison, sheep, goats, horses, deer and pigs may regularly require treatment of their hooves, particularly trimming, when they are not living in their natural environment. Some animals such as alpacas have nails instead of hooves, but may require trimming and care as well. Trimming or other treatments is frequently required for commercial animals such as cattle at a dairy farm or ranch, but may also be needed in other settings as well. The dairy industry in particular has come to depend on professional hoof trimming, for cattle that no longer can wander freely on rough natural landscapes and that also ingest relatively high amounts of feed tend to have rapid hoof growth that, without regular trimming, tends to lead to injury, pain, lameness, and premature death. In addition to trimming of hooves or nails, a variety of foot ailments such as foot rot may require special attention.

Unless otherwise specified or clearly inappropriate in context, subsequent references to “hoof trimming” should typically be understood to include not only direct trimming of the hoof, but to potentially include nail trimming and other treatments of the foot or lower leg of an animal.

Foot treatments such as hoof trimming can be challenging in many ways and can put humans and animals at risk. Restraining devices that hold a leg in place firmly enough for hoof trimming may block access to significant regions of the hoof where injuries or damage may require care, or may make it difficult or impossible to safely reposition the leg while elevated or restrained. For example, a worker may need to modify the grip on a leg in order to adjust the position of the hoof or foot relative to a restraining device for proper treatment, such as when a wound is noted between the claws or on the underside of the foot. Opening or loosening a leg restraint on an already retrained and nervous animal can lead to loss of control of the leg and injury to the worker or animal. The inability to gain proper access to an injured hoof for treatment also means that the animal will continue to live with the pain of the injury, shortening her life as a result.

Thus, there is a need for improved systems that can increase the ability of a worker to access various parts of the hoof as needed, and in particular to maintain adequate control of a leg while allowing adjustment of the position of a hoof relative to the restraining device for that leg with little risk of injury. In some cases, there is also a need for improved leg repositioning methods or devices therefor, in combination with hydraulics such as automated hydraulics and restraining devices that can hold an animal gently in a substantially upright position without tipping the animal to the side or applying undue pressure to any part of the animal. There may also be a need for improved restraining methods that not only allow for repositioning of a leg relative to one or more of the restraining devices in use, but also provide rapid and safe release of the animal when the treatment is complete.

There is also a need for improved systems in treating and preventing the injuries and maladies that can lead to lameness.

The needs described above are provided by way of example only. It should be understood that while the various methods, devices, and systems described below may each provide useful solutions to one or more of these needs, not every invention as claimed need individually fulfill all or any specific one of these exemplary needs.

### SUMMARY

In order to safely and securely adjust the position of an animal’s leg held in a restraint suitable for hood trimming, it has been found that a two-stage grasper in association with an animal trimming chute can provide the restraint and adjustability needed to handle a variety of hoof trimming challenges. The grasper comprises two stages that each serve to clamp a portion of the animal’s leg. The grasper acts somewhat like a hand with two or more independently movable elements, an upper stage and a lower stage, that move relative to a knee board that may be rigidly fixed in place. The cooperation of the upper and lower stages with the kneeboard can hold a lower section of an animal leg securely in place as they clamp down on the lower leg, allowing a trimmer to safely trim the hoof and treat the lower leg, as needed.

The lower stage of the grasper has a relatively narrow contact width and a the relatively broader upper stage has a substantially greater contact width. The contact width is the maximum width of a movable stage contacting the animal’s leg measured in the direction that extends along the length of the animal’s leg. The upper stage provides a relatively broad clamping surface that extends along a significant fraction of the animal’s lower leg (e.g., for a typical cow, it may extend for at least 3 inches, 4 inches, 5 inches or 6 inches along the leg below the knee, such as from 3 inches to 14 inches, from 4 inches to 12 inches, or from 3 inches to 10 inches, or alternatively, over a length of at least 10%, 15%, 20%, 25%, or 30% to less than 65% of the length of a typical adult animal’s lower leg, extending from the top of the hoof or nail to the knee). The relatively wide upper stage of the grasper provides significant support capable of restraining the animal’s leg even without the benefit of the lower stage. The ratio of the contact width of the upper stage to the contract width of the lower stage may be at least any of 1.2:1, 1.5:1, 2:1, 3:1, 4:1, 5:1, and 6:1, and in some aspects to express the ratio as being within a range, the upper limit may be 5:1, 7:1, 10:1, 20:1, and 30:1, giving ranges such as from 1.2:1 to 30:1, etc. Similar ratios can apply to the ratio of the maximum width of the movable clamping surface of the upper stage to the maximum width of the movable clamping surface of the lower stage.

The upper stage may be provided with a belt attachment feature such as a loop or slot allowing a belt such as a fabric belt to be threaded therethrough so that it can be used to assist in providing a safe level of clamping force on the animal’s leg. In some versions, two or more belt attachments may be provided to engage with two or more belts to provide a broader region of compression and control for the upper stage with the aid of the belts.

The lower stage of the grasper provides additional support to restrain the lower leg of the animal nearer the hoof and may also provide a belt attachment feature such as a slot or loop to engage with a belt. In one version, the lower stage may be adapted to fit between the bulb of the hoof and the dewclaw (for animals such as cows that have a dewclaw or related structure) or other region shortly above the hoof. In some versions, the lower stage is adapted to engage a region above the hoof and well below the knee, such as from 1 inch to 8 inches above the hoof, less than 10 inches or less than 6 inches above the hoof, or a distance ranging from immediately above the hoof to about 10%, 12%, 15%, 20%, 25%, 30% or 35% of the length of the lower leg of the animal.

The upper and lower stages may both pivot around a common pivot axis such as a cylinder, or distinct pivot axes may be used, or motion other than pivoting may be used to provide the clamping force for the stages. The grasper is initially oriented with the pivot axis or axes being substantially vertical such that the upper and lower stages when open may be placed onto the lower leg of the animal and then be closed and secured around the leg. The opening and closing of the two stages may be done via hydraulic pistons or other means, with the cinching of one or more belts being one method for firmly securing the upper stage on the upper portion of the lower leg of the animal. After being closed, the lower stage may be secured by a hydraulic piston or other means. The grasper is rotatably connected to the grasper arm assembly and can be rotated to turn the pivot axis from a substantially vertical to substantially horizontal position, thereby bending the leg of the cow at the knee such that the lower leg is raised and held in place for trimming.

With both the upper stage and lower stage of the grasper secured on the lower leg of the animal, trimming of the hoof can be safely conducted. However, if treatments of the hoof or region around the hood are needed other than trimming, access to the region can be provided by releasing the lower stage. Alternatively, if the position of the lower leg relative to the grasper needs to be adjusted to facilitate treatment, enhance comfort, or resolve other issues, adjustment may be possible without losing safe levels of restraint by releasing the lower stage and then applying pressure to the knee or upper leg to move the leg slightly in the upper stage before again applying the additional restraint of the lower stage. Slight relaxation of the upper stage may be helpful in some cases. A control system with suitable sensors and rapid response in clamping may be used to make such an adjustment with only momentary releasing of applied pressure.

In one version, an animal trimming chute such as a cattle trimming chute is provided having a frame with openings at the front and rear with at least one pair of the graspers described herein rotatably mounted on the frame and placed, for example, in the front of the chute for grasping and bending the front legs.

An animal can enter at the rear of the frame and walk toward the front, where a gate can engage with the shoulder to allow the head to project past the gate while blocking further forward motion of the animal. As the animal enters the trimming chute, a “comealong” device near the rear of the frame can move into place to gently push the animal forward from behind while preventing backward retreat from the chute. The comealong or its supports or the belly band that may be suspended therefrom may be instrumented with load cells, accelerometers, etc., to monitor animal load and motion in contact with the comealong. The chute or more specifically, for example, the belly band or clamping elements of the grasper (e.g., the upper and/or lower stage) may also be instrumented with cardiovascular monitors or sensors such as a pulse detector, EKG tools, blood pressure measurement devices, and a blood oxygen sensor or other medical sensors to monitor the health and stress levels of an animal.

The belly band, such as a band of a flexible material such as rubber, cloth, or leather may be lying on the floor of the chute as the animal enters, but once the animal has moved forward and is in the proper position, the belly band may be raised with hydraulics, electric motors, manual use of ropes and pulleys, etc., to engage with the belly of the animal (e.g., the brisket region of a cow) and support the animal. Complete lifting off the floor is generally not needed but could be done with assistance from the belly band if desired. Once supported with the belly band, front legs may be trimmed using the improved grasper described herein, with one leg raised or both front legs raised at the same time. The rear legs may be trimmed as well using a similar grasper or by using systems of belts and ropes that pull rear legs to bring one hoof at a time, or both hooves simultaneously, to an elevated position suitable for trimming. All such actions may be enhanced with hydraulics or other power sources, and motions can be automated or activated with simple actions such as pressing a button, issuing a voice command, etc.

The grasper for the front legs in particular is held on a shoulder-mounted grasper support frame in which a rotating pivot of the shoulder mount rotates on a rod that may be generally vertical. An upper arm portion of the shoulder-mounted frame extends from the shoulder mount to support an elbow joint, which rotatably connects to an upper arm portion of the shoulder mounted frame that connects to the grasper. Thus, the grasper can readily move in a substantially horizontal plane away from or toward a cow in the chute. In one version, the pivot axis of the elbow is generally parallel to the shoulder mount such that the rotation of the forearm and upper portions of the shoulder mounted frame can move substantially the same plane, such as the horizontal plane. The forearm portion engages with the upper portion (near or at the upper stage) of the grasper.

The grasper as it contacts an animal may typically be in an initially vertical position in which the axis of rotation of the upper stage is substantially vertical, but after the upper and lower stage are activated to hold the animal’s leg in place, the grasper may then be rotated by roughly 90 degrees or from about 45 to 130 degrees to bend the leg into position for hoof trimming. This may be assisted by the use of a hydraulic cylinder mounted on the frame of the chute or by other means to pull ropes, chains, or belts that turn to grasper to the proper position.

In one version, a handle on the grasper also comprises at least one control for activating motion control equipment to automatically move the grasper to a desired position, thereby easing the burden on a trimmer in moving an animal leg into position for trimming.

In some versions, the grasper is enhanced with data from various sensors to improve operation. For example, strain gauges, load cells, accelerometers, motion detectors, position detectors and related tools associated with, for example, the upper stage (e.g., the broad clamping surface), lower stage (e.g., the relatively narrow clamping surface), and/or knee board may be used to measure the force the animal is applying to resist restraint of a leg to ensure that adequate clamping pressure is applied. Such measurements in combination with automated controls can be used to release and reapply clamping force in the upper stage in order to reposition a leg by momentarily relaxing the clamping force and making an adjustment in position. Doing this while the animal is already trying to move the leg could result in excessive motion of the leg, but with proper control the correct placement of the leg can be achieved with the devices, systems and methods disclosed herein.

In some versions, the chute comprises or is operably associated with an ultrasonic system for measuring characteristics of the hoof or other regions of the leg of an animal or other parts of the animal. The ultrasonic system comprises at least one ultrasonic head, and in one version the grasper itself comprises or is associated with an ultrasonic head, such as a head mounted on a clamping surface of the grasper or cooperating with a clamping surface, wherein once the animal is secure, the head is in contact with the hoof, or can readily be moved into contact with the hoof for scanning in multiple positions if desired.

Other sensor technologies can also be associated with the grasper or the chute, such as infrared imaging and other optical sensors and measurement methods, microwave imaging, x-ray systems with appropriate safety shielding, ultrasonic imaging, etc. Acquisition, processing, storage, management, and application of the data so obtained can be handled using one or more processors in communication with one or more database servers or database systems, in cooperation with a module for animal identification (e.g., optical or electronic scanning of animal tags, biometric scans, and other recognition and identification tools), health and wellness diagnostic and forecasting tools. Communication between sensors, chute instrumentation, and a central database controller may be achieved using any suitable networking system or protocol such as WIFI, Ethernet, Bluetooth, fiber ADSL, VDSL, satellite or cellular communications including 2G, 3G, 4G, 5G, 6G, etc. protocols.

In other versions, the grasper is part of a smart trimming system that applies data obtained from one or more sensors relevant to animal health to enhance the hoof trimming operation or the treatment applied by a trimmer. Such a smart trimming system may comprise a trimming chute having a chute frame, one or more graspers movably attached to the chute frame for grasping an animal leg and moving the hoof in position for a hoof trimmer to effectively treat the hoof, a motion control system adapted to assist or control the motion of components such as the grasper and upper stage and lower stage via hydraulics, pneumatics, electronic actuators or motors, or other motion and position regulating tools, and a processor that receives data from one or more sensors and or one or more databases to obtain information pertaining to one or more animal characteristics relevant to hoof trimming practice such as hoof thickness, hoof health, leg health, animal pain levels, posture, gait, stress factors, load distribution, body temperature, agitation, animal eating habits, health record, etc., and in response to the data, enhancing the trimming operation by at least one of (1) providing instructions to the trimmer via electronic, visual, audible, or other means for special adjustments or procedures needed for an individual animal, (2) adjusting settings or behavior of one or more components of the trimming chute, such as modifying the clamping position of the upper stage of the grasper based on information received by the processor or modifying the clamping pressure or speed of motion of the grasper when it is turned to bend a leg into position, etc., and (3) tagging (digitally/virtually in an electronic record or physically) or calling for the tagging of an animal such that the animal will be slated for additional therapy or treatment, including adjustments in diet, shelter, exercise, medication, gene therapy, veterinary care, etc., beyond what takes place in the chute.

In one version, the smart trimming system comprises a trimming chute with a belly band for supporting an animal during hoof trimming, wherein the belly band is initially on the floor of the chute as the animal walks into the chute, but once the animal’s front legs have moved past the belly band, movable supports connected to the opposing ends of the belly band automatically begin lifting the belly band to provide desired animal support. This may be achieved with a control system that operates hydraulics, linear actuators, motors, or pneumatics, for example, that are operably associated with the belly band. The control system may receive data from load cells in the floor of the chute, a camera viewing the interior of the chute or the legs of the animals, an ultrasonic or photoelectric motion detector, a photo eye, microphones (e.g., for voice or sound analysis of the animal that may indicate pain), and other suitable sensors. Once the sensor output indicates that the animal’s front legs have moved past the belly band, the lifting of the belly band to a suitable height or suitable load level can be applied.

Such control systems with one or more sensors assisting in the actuation of various components of the chute may be especially helpful in improving efficiency of a hoof trimming operation by more quickly activating the head gate that keeps an animal entering the chute from exiting, while allowing the head of the animal to extend outside the chute, restraining the animals at the shoulders. Such systems, including those known as the Texas head gate, typically require precise timing by operators of trimming chutes to ensure that the gate is closed properly as the animal approaches the exit to block the shoulders. The use of rapid response gates with electronic or other actuators can improve accuracy, reduce the risk of an animal prematurely leaving the chute, reduce the risk of injury, and reduce animal agitation in the chute.

In another version, a smart trimming system receives data from animals outside the trimming chute to provide signals to the trimmer and/or to the components associated with the chute to enhance the operation for an individual animal based on data related to health, particularly hoof and leg health. The smart trimming system may prioritize animals for treatment based on triage to ensure that those with the most urgent need for treatment are treated, and animals may then be culled based on decisions from an algorithm or AI system/machine learning system associated with the smart trimming system for optimized treatment procedures and scheduling of a group of animals in light of the available treatment resources and operator staffing and skills.

The smart system may, for example, employ measurement of mobility characteristics to determine which animals are experiencing pain and this displaying unnatural movement or body mechanics. Such characteristics can be measured using accelerometers, load cells, vibration analysis equipment, video cameras, IR cameras, and the like. Locomotion scores, either manually or automatically determined, and application of various measurement methods to identify characteristics of bovine feet and motion issues can all be applied in some aspects. For example, the gait cycle of large mammals can be monitored with video camera and other tools such as accelerometers and analyzed to predict that an animal is suffering from pain and or the detection of lameness and foot pathologies. Relevant factors may include measurement or characterization of back arch, head bob, tracking up, joint flexion, asymmetric steps, and reluctance to bear weight, as discussed in F.C. Flower and D.M. Weary, “Effect of hoof pathologies on subjective assessments of dairy cow gait,” Journal of Dairy Science, vol. 89 (2006): 139-146, https://doi.org/10.3168/jds.S0022-0302(06)72077-X.

The graspers described herein may typically be used for the front legs. Trimming of the rear hooves may be done by a gripper built into the comealong that uses ropes, for example, to pull a rear hoof into place for efficient trimming. Graspers as described herein may be used for rear legs as well when desired or needed.

The motion of the grasper and many other components in complete animal trimming chutes for hoof trimming can be provided by any combination of hydraulics, manual power (e.g., the pulling of ropes in rope and pulley systems by hand), electric actuators such as electric linear drives, electric motors, electric pistons, etc., as well as pneumatic systems or any other systems for applying force or driving motion Electric actuators, for example, now offer power density comparable to hydraulics with the advantages of faster response times and relatively flexible programming for tailored performance.

In describing various aspects herein, it should be understood that every aspect or variation of each feature, element, method, process, system, and so forth, may be combined when feasible and suitable with any other such feature, element, method, process, system, and so forth.

Thus, by way of example only, the disclosure herein includes any of the following aspects:

Aspect 1. A grasper for hoof trimming of an animal comprising a knee board, a movable upper stage comprising broad clamping surface (a first clamping surface) and a movable lower stage comprising a relatively more narrow clamping surface (a second clamping surface), the upper stage and the lower stage both adapted to cooperate with the knee board to secure the lower leg of the animal.

Aspect 2. The grasper of aspect 1, further comprising at least one belt associated with the upper stage for securing the upper stage against the lower leg. The grasper of aspect 1, wherein the broad clamping surface of the upper stage provides a sufficient clamping length along the length of an animal leg to keep the leg secured when the lower stage is open.

Aspect 3. The grasper of any of aspects 1-2, wherein the ratio of the maximum width of the movable clamping surface of the upper stage to the maximum width of the movable clamping surface of the lower stage is from 1.2:1 to 30:1.

Aspect 4. The grasper of any of aspects 1-3, wherein the clamping length of the upper stage is at least 3 inches.

Aspect 5. The grasper of any of aspects 1-4, wherein the clamping length of the upper stage is at least 4 inches wide such as from 4 inches to 14 inches wide.

Aspect 6. The grasper of any of aspects 1-5, wherein the broad clamping surface is at least 50% wider than the relatively more narrow clamping surface.

Aspect 7. The grasper of any of aspects 1-5, wherein the upper stage comprises at least one loop associated with the broad clamping for receiving at least one belt to assist in providing clamping pressure.

Aspect 8. The grasper of any of aspects 1-7, wherein the upper stage comprises two loops associated with the broad clamping surface for receiving two belts.

Aspect 9. The grasper of any of aspects 1-8, wherein the broad clamping surface of the upper stage is rotatably attached to a pivot.

Aspect 10. The grasper of any of aspects 1-9, wherein the lower stage is rotatably attached to a pivot.

Aspect 11. The grasper of any of aspects 1-10, further comprising a sensor such as an ultrasonic head for measuring characteristics of the animal, a temperature sensor (e.g., a thermocouple, thermistor, IR sensor, etc.), or a sensor associated with at least one of the lower stage, the upper stage, and the knee board, the sensor being selected, for example, from a load cell, an accelerometer, a strain gauge, a position detector, a cardiovascular sensor, etc.

Aspect 12. The grasper of Aspect 11, wherein the sensor is an ultrasonic head and wherein the grasper is further associated with a processor and a database to store information obtained from the ultrasonic head, wherein the processor generates one or more values based on the information obtained from the ultrasonic head and the one or more values are stored in the database and associated with the specific animal.

Aspect 13. A chute for receiving animals for treatment of the lower legs or hooves of animals while in the chute, further comprising the grasper of any of the preceding aspects.

Aspect 14. A chute for receiving animals for treatment of the lower legs or hooves of animals while in the chute, comprising a frame, a front gate attached to the frame, a belly band for supporting the animal and connected to a lifting system attached to the frame, and a grasper attached to the frame via a rotatable linkage, the grasper comprising a knee board, a movable upper stage comprising a broad clamping surface and a movable lower stage comprising a relatively more narrow clamping surface, the upper stage and the lower stage both adapted to cooperate with the knee board to secure the lower leg of the animal when they are in a closed position.

Aspect 15. The chute of aspect 14, wherein the grasper further comprises any of the features of Aspects 1-12.

Aspect 16. The chute of either of aspects 14 and 15, comprising a right and left grasper each selected from any of the graspers of aspects 1-12.

Aspect 17. The chute of any of aspects 13-16, wherein the broad clamping surface and the relatively more narrow clamping surface are both independently movable between an open position and a closed position, the further comprising a first and second control systems to control the respective applied force to the broad clamping surface and the applied force to the relatively more narrow clamping surface when in the closed position.

Aspect 18. A method for hoof trimming, comprising guiding an animal into a trimming chute, the chute comprising a belly band for supporting the animal, and at least one movable grasper for securing the lower leg of an animal, the grasper comprising a kneeboard, a movable upper stage, and a movable lower stage, wherein after entering the trimming chute, the grasper is moved into a position to grasp the lower leg of the animal by placing the leg between kneeboard and both the upper stage and lower stage, then clamping the upper stage and the lower stage onto the lower leg of the animal, wherein a clamping surface of the upper stage contacts the lower leg along a contact length extending along the lower leg that is substantially greater than the contact length of the lower stage in the same direction, followed by rotating the grasper to bend the lower leg of the animal about the knee of the leg to bring the hoof into a position suitable for hoof trimming, followed by a hoof trimmer trimming the hoof.

Aspect 19. The method of aspect 18, wherein in response to a need for expanded access to the hoof or lower leg of the animal for treatment, expanded access is provided by releasing the lower stage without losing a secure grip on the lower leg of the animal.

Aspect 20. The method of aspect 18 or 19, wherein the rotation of the grasper is assisted by one of hydraulics, pneumatics, or electric devices.

Aspect 21. The method of any of aspects 18-20, wherein closing or opening of the upper stage is assisted by one of hydraulics, pneumatics, or electric devices.

Aspect 22. The method of any of aspects 18-21, further comprising electronically providing a message to the hoof trimmer to guide the hoof trimmer on special needs of the animal, the message being generated by a processor in response to data acquired regarding animal health by one or more sensors or detection systems selected from cameras, ultrasonic measurement systems, accelerometers, load cells, facial recognition systems, biometric identification systems, gait analyzers, and other sensors.

Aspect 23. An animal identification system comprising a database of animal characteristics associated with a measurement system for recording animal health and treatment data in the database, the system being associated with the grasper or any of aspects 1-12, or with the chutes of any of aspects 13-17, or with the method of aspects 18-22.

Aspect 24. A smart trimming chute for trimming the hooves of animals by an animal trimmer, comprising a frame, an entrance gate, an exit gate, a belly band lifting system, a comealong, and at least one grasper movably mounted on the frame for restraining the lower part of a leg, the grasper comprising a knee board that is operatively associated with a movable upper stage clamp and a movable lower stage clamp, and further comprising a trimmer guidance system in communication with one or more sensors and a processor that are adapted to receive and analyze data relevant to animal health from the one or more sensors, and adapted to make a recommendation for action to be taken by the animal trimmer responsive to the data relevant to animal health.

Aspect 25. The smart trimming chute of aspect 24, wherein the data relevant to animal health from one or more sensors comprise ultrasonic imaging data, gait analysis data, weight distribution data, step count data, indications of animal pain or adverse health conditions derived from analysis of at least one of photographs, video, animal sound recordings (e.g., recordings made in the chute, before the chute, or elsewhere analyzed for indicators of stress or pain), measurements of animal motion, and measurements of the animal’s physiological state (e.g., cardiovascular measurements such as pulse, blood pressure, etc., as well as body temperature, saliva measurements, blood analysis, dental health analysis, indicators of infection, facial analysis, etc., as well as gait analysis, etc.).

Aspect 26. The smart trimming chute of any of aspects 24-25, wherein the at least one grasper comprises a feature of any of the graspers in preceding aspects.

### BRIEF DESCRIPTION OF THE DRAWINGS

FIG. 1 a version of a grasper for grasping the lower leg of an animal.

FIG. 2 depicts several basic elements of a trimming chute including a front leg grasper.

FIG. 3 is a photograph of one version of a grasper.

FIG. 4 is another view of the grasper of FIG. 3.

FIG. 5 is another view of the grasper of FIGS. 3 and 4.

FIG. 6 is another view of the grasper of FIGS. 3-5

FIG. 7 is a view of the grasper of FIGS. 3-6.

FIG. 8 depicts a front portion of a partially assembled trimming chute showing a shoulder-mounted grasper support frame.

FIG. 9 depicts another view of the shoulder-mounted grasper support frame of FIG. 8.

FIG. 10 provides another view of the shoulder-mounted grasper support frame of FIGS. 8-9.

FIG. 11 is a flowchart showing the use of data about an animal obtained prior to entering the chute to tailor the treatment of the animal.

### DETAILED DESCRIPTION

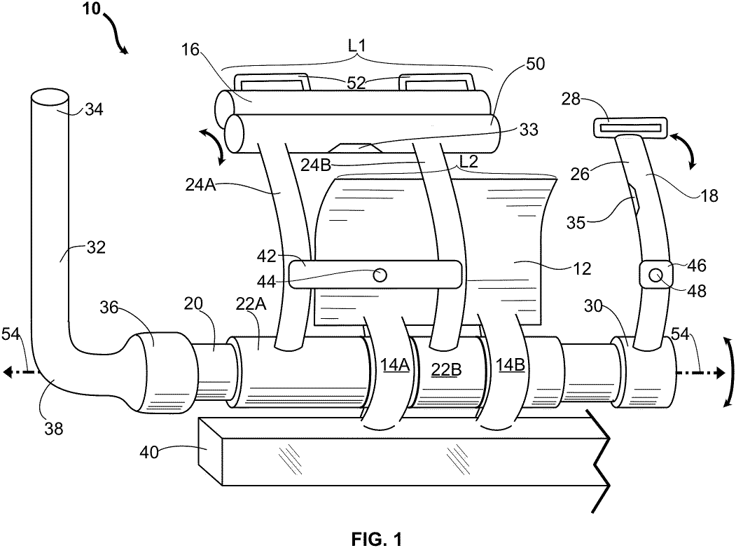

FIG. 1 depicts a grasper 10 adapted for grasping the leg of an animal (not shown) below the knee to facilitate hoof trimming or other lower leg treatments with the leg in a restrained position.

The grasper 10 comprises an upper stage 16 for grasping the lower leg (e.g., the upper or middle portions of the lower leg) of an animal typically just below the knee (not shown) and a lower stage 18 for grasping a lower portion of the leg near the hoof and, when applicable, grasping the region between the dewclaw and the bulb (also called the heel bulb) of the hoof (not shown). Both the upper stage 16 and the lower stage 18 can rotate about an axis of rotation 54, here shown passing through a cylinder 20 serving as a pivot support (though other forms of pivot supports could be used and the upper stage 16 and lower stage 18 need not share the same axis of rotation). Upper pivots 22A and 22B are connected respectively to a first rod 24A and a second rod 24B, which in turn are connected to the clamping bar 50 of the upper stage 16, while a lower pivot 30 is joined to a rod 26 that serves as a clamping surface for the lower stage 18. The rods 24A, 24B and 26 may have any reasonable cross-sectional shape such as circular, elliptical, rectangular, etc., and may have a width (diameter or maximum diameter) of at least 0.5 inches such as from 0.5 inches to 2.5 inches, or from 0.5 inches to 1 inch, etc., and like most other components described herein, may be made from any suitable material such as carbon steel and other ferric alloys, aluminum, fiberglass, plastics, composite plastics, titanium, sintered metal, etc. The upper stage 16 comprises a clamping bar 50 with a width L1 that extends substantially parallel to the direction of the axis of rotation 54 that passes through the centerline of the cylinder 20. The upper stage 16 cooperates with a knee board 12 having a width L2. The knee board 12 in this aspect is rigid and not rotatable, but could be rotatable or adjustable if desired. The width L1 may be similar to the width L2, though it may be greater or shorter by any suitable factor such as less than 10%, 20%, 30% or 40% of L2.

As depicted, the clamping bar 50 further comprises two loops 52 for engaging with two restraining belts (not shown) that can pass through the loops 52 and be tightened to hold the upper stage 16 firmly in place. The lower stage 18 also comprises a loop 28 for engaging with a restraining belt (not shown) that can be cinched to secure it in place. Other suitable means may be used for holding clamping bar 50 and the lower stage rod 26 in place, such as ratchet mechanism or other locking mechanisms in the respective pivots, or other restraining devices or movable barriers (not shown).

Movement of the upper stage 16 may be controlled manually or by mechanical or electric systems such as hydraulics or electric actuators (not shown). The upper stage 16 is depicted having a mounting plate 42 that engages the first and second rods 24A, 24B with a seat 44 for receiving a rod or other force-delivering component from a hydraulic unit (not shown) or other device for controlling motion of the upper stage 16. The lower stage 18 also has a mounting plate 46 attached to the rod 26 further comprising a seat 48 adapted to receive a rod or other force-delivering component from a hydraulic unit or other device for controlling motion of the lower stage 18. The grasper 10 may be adapted to have one or both of the upper stage 16 and lower stage 18 be subject to manual control of position instead of or in combination with hydraulic or other non-manual position control systems.

The knee board 12 may be substantially rectangular or any other suitable shape and may have a three-dimensional structure with some degree of curvature to more comfortably conform with the typical shape of the animal legs to be treated. It may be made of rigid material such as steel, polycarbonate, etc., but may also comprise padding such as neoprene or rubber. The knee board may be adjustable or fixed in place. It may be attached to the cylinder 20 via one or more connections such as the connection members 14A, 14B, and may be attached to other structures such as the beam 40.

The upper end (left end in FIG. 1) of the cylinder 20 is adapted to receive a mounting element 32 adapted to attach the grasper 10 to a shoulder-mounted frame (not shown). The mounting element 32 comprises a cylindrical mounting rod 34 that bends at an elbow 38 and then joins to a receiving mount 36 that can receive and fixedly connect with the cylinder 20. Of course, many other forms of connection between the grasper 10 and a chute (not shown) can be used.

Instrumentation such as various sensors may be attached to or associated with the various components of the grasper 10 such as upper stage 16 and/or the lower stage, where FIG. 1 depicts, by way of example only, a first sensor 33 attached to or disposed within the broad clamping surface 50 of the upper stage 16 and a second sensor 35 attached to or disposed within the rod 26 of the lower stage 18. Such sensors may each be independently selected from a load cell, strain gauge, or other force or sensor for measuring force or pressure sensor, an accelerometer or other vibration detector; a position detector (e.g., position of the broad clamping surface 50 or the relatively more narrow clamping surface of the rod 26) such as sensors of the rotation angle of any one or more of the pivots 22A, 22B, 30, inclinometers, visual monitors of position, angular or rotary position sensors, Hall-effect position sensors, wireless position sensors, a linear variable displacement transducer (LVDT) as a position sensor, absolute linear sensors, potentiometers, actuators such as programmable electric actuators, visible gauges, and the like. A plurality of sensors may also be contemplated in such locations and elsewhere, such as a combination of position or force sensors as well sensors for body temperature, pulse, blood oxygen, vibration, stress factors or infection markers in saliva, etc.

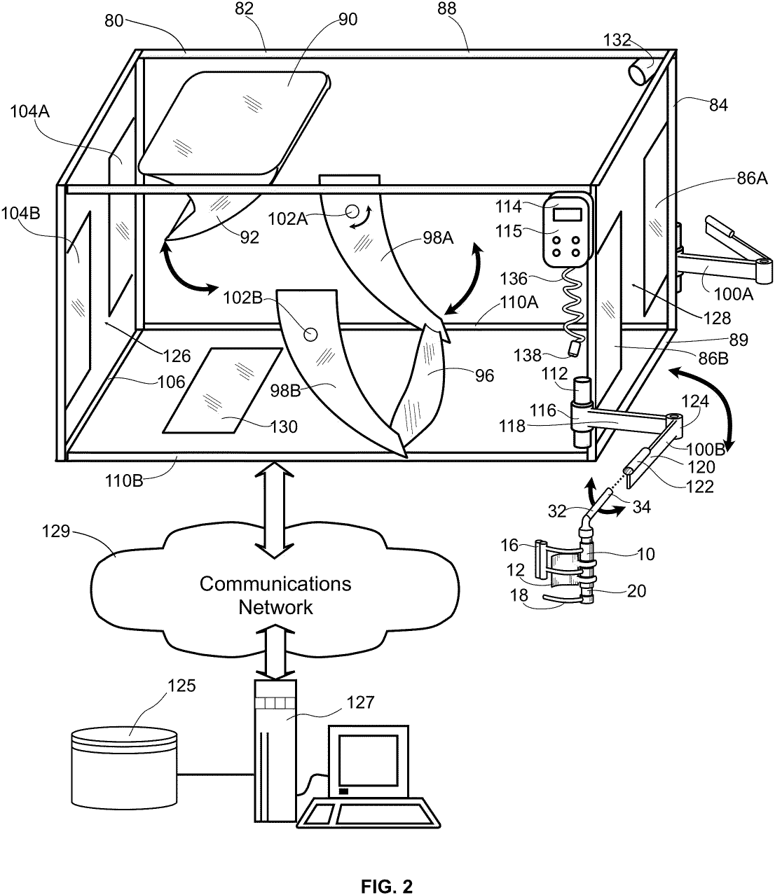

FIG. 2 depicts a cattle chute 80 comprising a frame 82, but with many support structures and peripheral elements not shown to more clearly show certain components. The frame 82 comprises an upper section 88, a rear section 106 having an entrance gate 126 with entrance doors 104A, 104B, a front section 89 comprising an exit gate 128 having exit doors 86A, 86B, side portions 110A, 110B, a “comealong” 90 mounted on the top of the chute 80 having a rotatable lower section 92 that can rotate downward and toward the front section 89 to help drive an animal forward, and a belly band 96 for supporting the brisket or belly portion of an animal, attached to a pair of pivotable belly band arms 98A, 98B that are mounted on opposing sides 110A, 110B of the frame 82 and rotate about pivots 102A, 201B. Also attached to the frame 82 near the front section 89 are a pair of shoulder-mounted front-leg grasper support frames 100A, 100B, details for which are enumerated for the foremost support frame 100B. The support frame 100B is attached to a shoulder mount 112 having a shoulder pivot 116 connected to an upper arm section 118, which is connected to an elbow joint 124 that connects to a forearm section 120 which can rotate relative to the upper arm section 118 via the elbow joint 124. The forearm section comprises an open cylindrical mount 122 (though many other configurations for rotatable mounts could be used) which is adapted to receive the cylindrical mounting rod 34 of the mounting element 32 of the grasper 10 shown near but not yet connected to the grasper support frame 100B. Once the cylindrical mounting rod 34 is inserted into the cylindrical mount 122, the grasper 10 that hangs from the cylindrical mounting rod 34 can be swung into the chute 80 through the rotation of the grasper support frame 100B about the shoulder mount 112 and the elbow joint 124 to place the open grasper 10 over the leg of an animal (not shown). Hydraulic pistons (not shown) or other means can be used to adjust the position of the upper stage 16 and the lower stage 18, and belts (not shown) can be used to firmly hold the upper stage 16 and the lower stage 18 in effective clamping positions. At that point, the grasper 10 can be rotated upward relative to the cylindrical mount 122 to a relatively horizontal position in order to bend the lower leg of an animal about the knee. This upward motion of the grasper 10 can be achieved using a hydraulic cylinder, pneumatic devices, electrical drives, or other means to apply force to ropes, cables, chains, belts, or other connections (not shown) between the hydraulic cylinder and the grasper 10 to apply sufficient force to lift the grasper 10 and the lower leg of the animal into a suitable position for hoof trimming or other treatments. Once the treatment is complete, the hydraulic or other force or restraint is relaxed, allowing the grasper 10 to swing back down such that the animal’s leg is again in the normal standing position, and the belts can be released and the upper stage 16 and lower stage 18 opened to allow the grasper 10 to release the leg, after which the grasper 10 can be rotated back out of the chute 80 to no longer impede animal motion once the front doors 86A, 86B are opened.

Many versions of the gates 86A, 86B, 104A, 104B and other components can be considered. For example, automated devices (not shown) may be used to control opening and closing of the gates. The gates 86A, 86B may be oriented at an angle relative to the front plane of the chute 80 and may travel in tracks to control the position of the gates.

FIG. 2 also illustrates the use of sensors associated with the chute 80, such as a weight distribution measurement platform 130 comprising load cells and optional accelerometers to obtain information about the animals distribution of weight between legs and/or on individuals hooves, which can be interpreted by an algorithm on a processor (not shown, such as a processor operatively associated with a computer and software on a computer readable medium, optionally associated with a database) to guide a trimmer regarding the needs of an animal. Such information can be stored in a database (not shown) for future reference and optionally for customizing future treatments, including treatments in the chute, based on health-related data for individual animals stored in the database.

The weight distribution measurement platform 130 may be much longer or wide than depicted, and a plurality of such platforms may be provided, including platforms for measuring load distribution before and after treatment.

Another sensor is shown as a camera 132 mounted in the top of the chute 80, where the chute can more readily be kept clean and free of animal waste. The camera 132 can monitor animals for signs of pain, for improper gait, for condition of hooves, skin health, anxiety, etc. Observations may be made using conventional cameras as well as IR cameras, etc. Images may be processed by image analysis or other medical diagnostic software using a processor (not shown) in association with a database (not shown) for storing results obtained by analysis of images.

Another sensor depicted is an ultrasonic scanner system 114 with a movable ultrasonic head 138 connected to the body 115 of the ultrasonic scanner system 114 with a flexible cable 136. The ultrasonic scanner system 114 may be mounted in any convenient location, but is shown here on the upper right side for convenience and visibility. The ultrasonic scanner system 114 may be powered by electrical power from a cable (not shown) or by batteries (not shown), etc. Ultrasonic heads 138 in other aspects may be embedded in or attached to the grasper 10, such as being associated with the lower stage 18 or the clamping bar 50 of the upper stage 16 or the knee board 12, a configuration not explicitly shown. Data from the ultrasonic measurement may be analyzed to give relevant instructions to a trimmer via a voice, text, or visual signal such as one displayed on an output device on the ultrasonic scanner system 114. The instructions may give guidance on where to trim in relationship to the bone inside the hoof region for a better trim, or indicate where trouble spots are detected in need of special care such as a wrap or medication. Application of a wrap in response to animal needs detected by sensors or by visual inspection may require adjustment of the grip such as release of the lower stage 18 in order for the trimmer to apply the wrap. In this case, the release of the lower stage 18 does not permit the animal to move its leg substantially or to withdraw its legs from the grasper 10 because of the broad clamping area of the upper stage 16 and the presence of one or two belts (not shown) applying pressure and fortifying the restraint on the animal.

In one aspect also shown here, the chute 80 may be in communication with a computer system 127 comprising a processor and in communicative association with a database 125 that can store data relevant to animal health as well as past and planned treatments pertaining to individual animals or groups thereof to be treated in the chutes disclosed herein. The computer system 127 can receive data from the various sensors of the chute 80, from other sensors or measurements made throughout a facility or operation for managing the animals in question, or from the operator (not shown) of the chute via any suitable communication means. One aspect shown here involves a communication network 129 linking the computer system 127 to the chute 80. Communication may occur via wire or wireless methods, including WIFI, 5G, 6G, NFC, Ethernet, or any known protocol, etc. Thus sensors associated with the chute 80 and operator input may be provided to the computer system 127 and stored in the database 125 along with other data from health-related measurements made in other settings for the animals (not shown). Software associated with the computer system 127 (e.g., on storage media in the computer or other computer readable media) can then be run by the processor (not shown) to analyze data in the database 125 and make recommendations to operators of the chute 80 to guide them in making appropriate treatments. In some aspects, improved treatment may require adjusting leg position during treatment by releasing the lower stage 18 while still securing the leg with the upper stage 16 of the grasper 10.

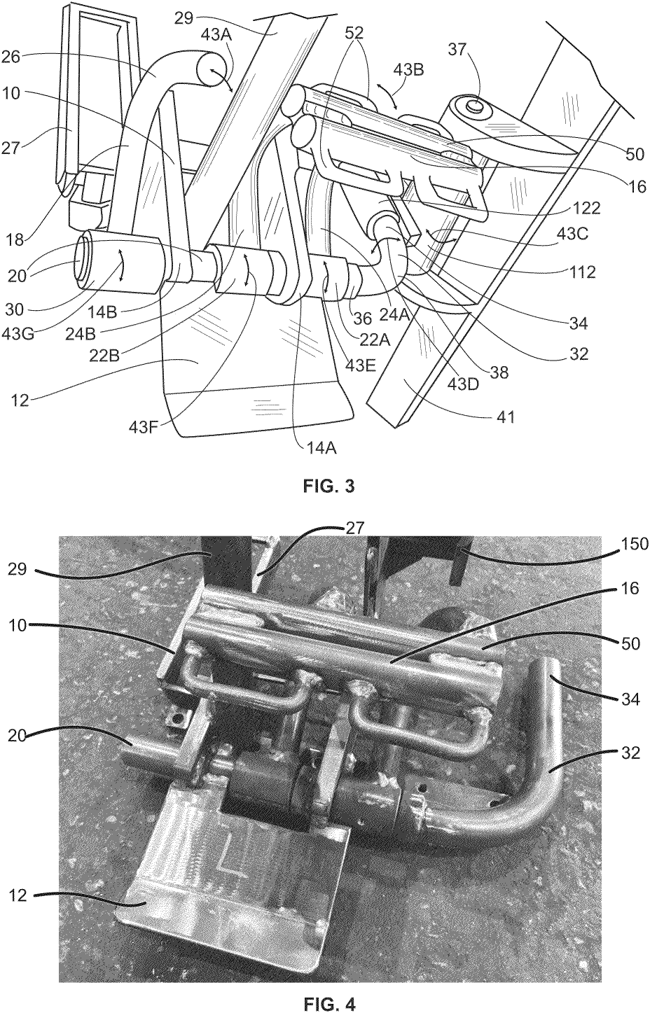

FIG. 3 is a drawing based on a photograph of a prototype of one version of a grasper 10 showing the upper stage 16 and its clamping bar 50, the lower stage 18, the knee board 12, the mounting element 32 with the cylindrical mounting rod 34 inserted into the cylindrical mount 122 and also into the receiving mount 36, etc. The cylindrical mount 122 is joined to shoulder mount 112 via a shoulder pivot (not shown since the linkage details are blocked in this perspective) that supports the grasper 10 and allows the grasper 10 to be rotated in the horizontal plane, as shown by rotation arrow 43C, while the cylindrical mount 122 allows the grasper 10 to be rotated vertically, as shown by rotation arrow 43D, between the displayed horizontal orientation or downward into a vertical orientation (not shown) in which the grasper 10 can be used to clamp onto the lower leg of an animal (not shown), after which it can be rotated to a more horizontal position for convenient treatment of the hoof (not shown). The positioning of the grasper 10 can be done by hand or mechanically with the aid of pulleys, chain drives, pneumatics, hydraulics, etc., as desired. In the aspect shown here, a positioning linkage 29 is shown, which is a shaft connected to the grasper 10 that can be moved by the action of pulleys or other mechanical systems acting on a remote end (not shown, but above the view shown here) to regulate the position of the grasper 10, particularly moving the grasper 10 between the vertical and horizontal positions.

Various rotation arrows 43A through 43G show the motion of various elements. Rotation arrow 43A shows the motion of the curved rod 26 of the lower stage 18 as the attached lower pivot 30 rotates, as shown by rotation arrow 43G, about the cylinder 20 serving as a pivot support. A loop element (not shown) may be attached to the rod 26 such that a belt (not shown) or other means can secure the rod 26 when in a closed position after rotating downward from the displayed open position to secure the lower leg on animal (not shown) with respect to the knee board 12. Rotation arrow 43B was previously mentioned, showing the rotation of the clamping bar 50 of the upper stage 16, while rotation arrows 43E and 43F show the rotation, respectively, of the first rod 24A and the second rod 24B of the upper stage 16 about the cylinder 20 via the attached pivots 22A and 22B, respectively.

Also shown are the locking mechanism of the pivot shaft 37 associated with the shoulder mount 112, a support beam 41, and the upper stage bracket 27 which is adapted to hold a hydraulic cylinder or other position control device to drive the lower stage 18 (i.e., the rod 26) between open and closed positions.

FIG. 4 is another view of the grasper 10 of FIG. 3, with the lower stage 18 removed, thereby more clearly showing the cylinder 20 that serves as a pivot support for the upper stage 16 and the lower stage 18 (not shown). Also shown in this view is the upper stage bracket 27 which can support mechanisms (not shown) to drive the lower stage 18 between open and closed positions.

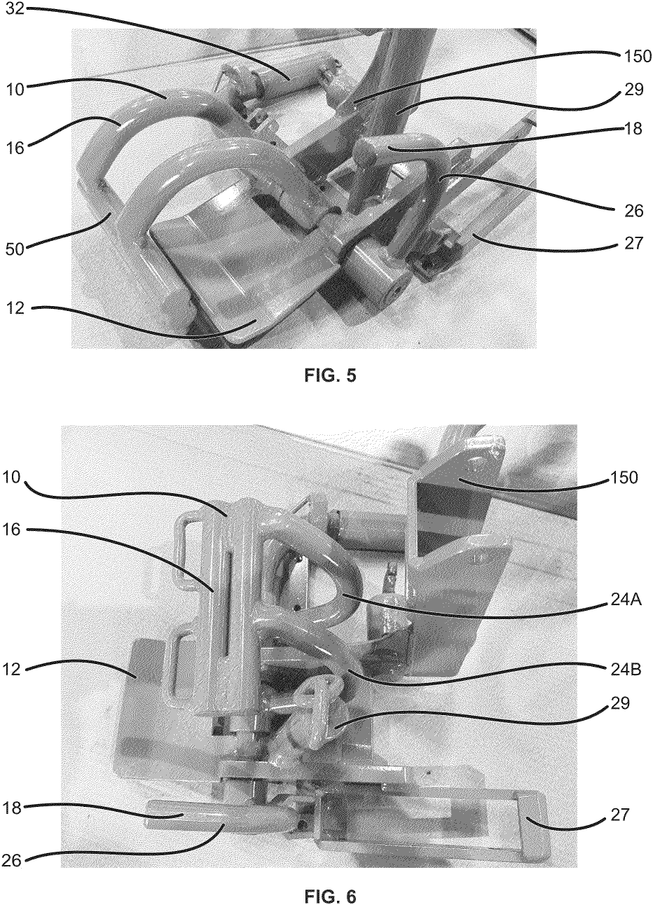

FIG. 5 is another view of the grasper 10 similar to that of FIGS. 3 and 4, here showing the knee board 12, the upper stage 16, the lower stage 18, the lower stage bracket 27, the upper stage bracket 150, the positioning linkage 29, etc.

FIG. 6 is another view of the grasper 10 of FIGS. 3-5 also showing the first rod 24A and a second rod 24B of the upper stage 16, the positioning linkage 29, the upper stage bracket 150, etc.

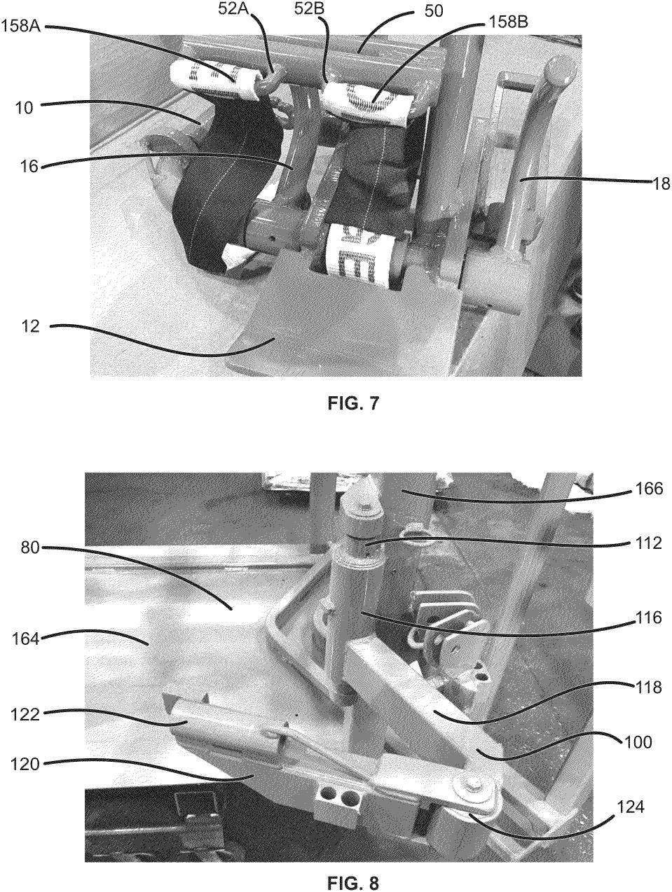

FIG. 7 is another view of the grasper 10 of FIGS. 3-6 further showing two belts 158A and 158B inserted through the loops 52A, 52B attached to the clamping rod 50 of the upper stage 16. Also shown are the knee board 12 and the lower stage 18.

FIG. 8 depicts a front portion of a partially assembled trimming chute 80 to show the location of a shoulder-mounted grasper support frame 100 mounted on a front right support column 166 with a shoulder pivot 116 attached to a shoulder mount 112 and rotatably connected to an upper arm section 118, which is connected to an elbow joint 124 that connects to a forearm section 120 which can rotate relative to the upper arm section 118 via the elbow joint 124. The forearm section comprises an open cylindrical mount 122 which can receive the cylindrical mounting rod 34 (not shown) of the grasper 10 (not shown). Other linkages or mounting systems can be used, of course. Also shown is the base 164 of the chute 80, which may comprise sensors (not shown) such as vibration sensors, pressure sensors or load cells, etc. mounted on or otherwise associated with the base 164.

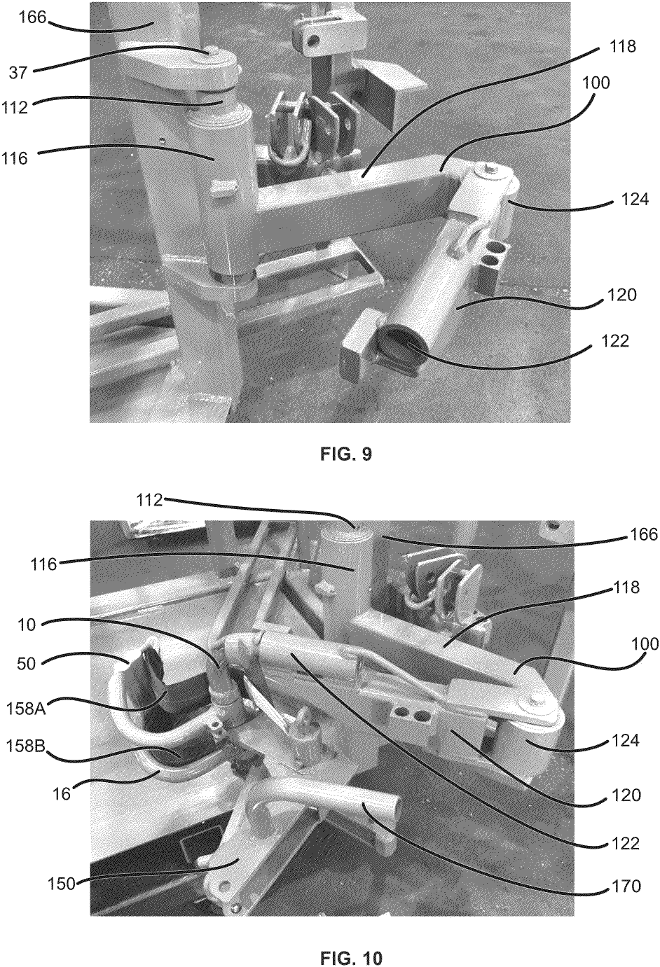

FIG. 9 depicts another view of the shoulder-mounted grasper support frame 100 of FIG. 8.

FIG. 10 provides another view of the shoulder-mounted grasper support frame 100 of FIGS. 8-9. Also shown here are the belts 158A and 158B that assist in providing clamping pressure for the upper stage 16. Also shown in this view is the upper stage bracket 150 and a handle 170 attached to the upper stage bracket 150 to assist in lifting and moving the grasper 10 when, for example, manual adjustment is desired.

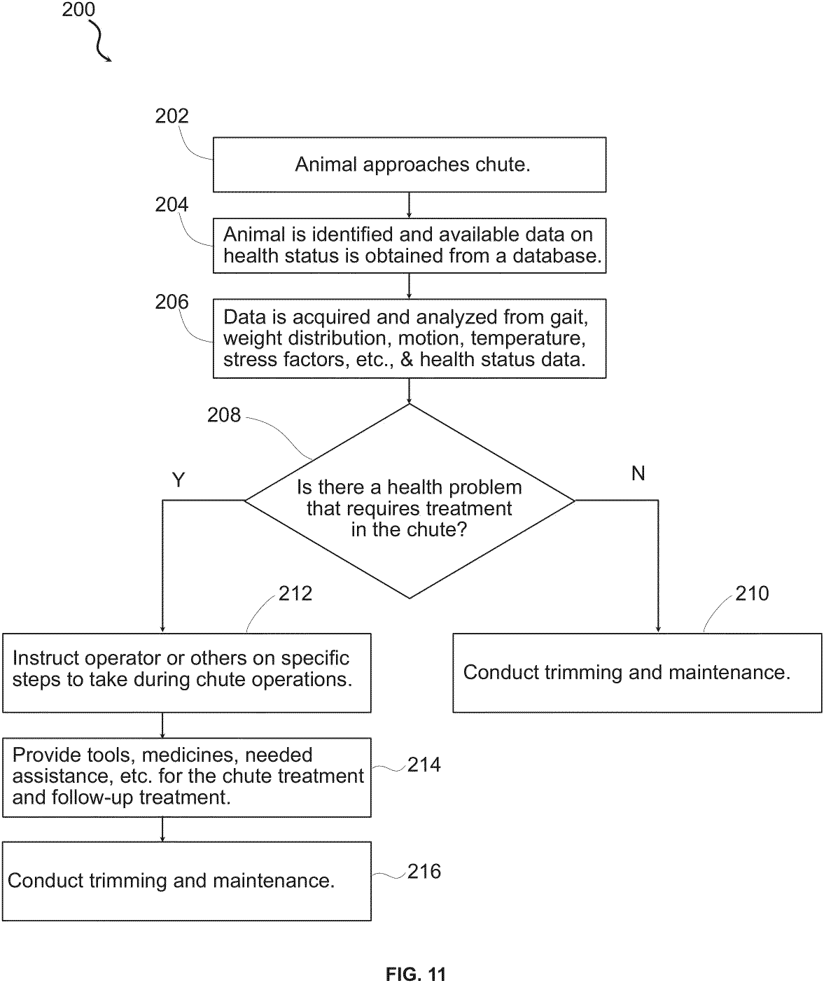

FIG. 11 is a flowchart depicting a method of customizing the treatment of an animal 200. Steps shown here are not necessarily in chronological order, one or more steps may be combined and accomplished substantially at the same time, or may be split into further substeps, and conducted in any suitable order. In step 202, an animal approaches the chute for trimming or other treatments. In step 204, the animal is identified and available data on health status is obtained from a database. The database (not shown) may comprise information from veterinary care that include blood test results, body weight tracking data, growth data, observations about feet, skin, teeth, eyes, tongue, udder, etc., milk analysis for dairy cattle, body temperature, indicators of infection, tests for infection, muscle tone, hide or hair characteristics, saliva measurement (e.g., for detection of stress related compounds), dental inspection, eating behaviors, sleep behavior, characteristics of interactions with other animals and humans, etc.

Identification of the animal can be based on imaging and comparison to a database to give animal recognition systems similar to facial recognition for humans. Identification may also be done using tags associated with the animal, such as an ear tag, a collar tag, a subcutaneous tag, etc., and such tags may employ RFID, NFC, or other wireless transmission means as well as the use of printed characters, magnetic strips, or other means for storing and providing information related to unique identities of animals. Identification can also be done manually rather than automatically, such as by reading a tag or noting other identifying markings and then entering the ID information into a user interface.

| In step 206, data is acquired and analyzed from measurements of gait, weight or force distribution, motion, body temperature, stress factors, human observation, machine observation guided by AI or machine learning, etc., and combined with the health status data from step 204. Such data may, in some aspects, be obtained at least in part while the animal is approaching the chute or after the animal has entered the chute. At least a portion of such data may therefore have been obtained within 1 hour of entering the chute, such as within 45 minutes, 30 minutes, 15 minutes, 10 minutes, 5 minutes, 3 minutes, or 1 minute of entering the chute. This data may then be combined with health status data already in the database that was retrieved in step 204.

The combined data can then be used in step 206 for analysis to yield information from the analysis about the animal’s apparent health issues and needs. The analysis may rely at least in part on artificial intelligence engines and/or input from a veterinarian or other human experts, such that diverse information about an animal is used to diagnose health conditions and make recommended treatments. A decision is made in step 208 to determine if the animal has a health problem that should be treated while in the chute. If the answer is yes (Y), then a branch is pursued beginning with step 212, in which instructions are provided to an operator or others on specific steps to take during chute operations. Providing such instructions may be done via a text message, a notification displayed on a tablet or monitor, verbal instructions played by a sound system, or any other means. Next, in step 214, the operator or others are provided with any needed tools, medicines, or other items for the customized treatment. Such items may include a syringe provided with a dose of an antibiotic, nutrient, etc., or wound dressings, braces, and other devices to provide aid and care for an animal. Such items may be provided automatically or directions may be provided causing others to provide the needed materials to the operator, or instructions may be given directly to the operator directing the operator to obtain such supplies. Finally, in step 216, the operator conducts trimming and maintenance, which may be routine or may have elements specially adapted for the current needs of the animal, such as customizing the trimming of an injured hoof to minimize the risk of injury or to accelerate healing, in combination with other palliative steps.

If the answer in step 208 is no (N), then a branch is pursued beginning with step 210, in which normal trimming and maintenance is conducted.

The recommended actions and the action steps taken by the operator(s) can then be recorded in a database (not shown) storing information about the animal in question.

It should be understand that more than one person may perform the role of the operator/hoof trimmer in this and related methods. In some aspects, one or more of the tasks described may also be performed by robotic devices when suitable.

### FURTHER DETAILS

In some versions, the cattle chute may be equipped with a variety of sensors and may also be in cooperation with external sensors. The sensors may be inside or outside the chute, either directly mounted on the chute or its peripheral components or may be remote but in communication with a control system for the chute, with communication occurring through radio or other wireless signals (WIFI, 5G, etc.), cable, etc. External sensors include those that can monitor conditions of animals to determine if special treatments are needed, to measure the quality of the treatment by examining one or more factors both before and after the treatment, etc. Such sensors may be used to monitor animals wherever they are, indoors or outdoors, and may be adapted to recognize and track individual animals. For example, for a herd of dairy cows, load distribution platforms may be provided in the return lane from the milking parlor to regular track cows daily, combined with optical sensors to read tags and optionally to track gait or other signs of pain or other problems.

In general, such sensors and systems, for use with the chute or for use external to the chute may include:
Cameras and related optical systems for analyzing hoof thickness, leg health, regions of the hoof or leg in need of treatment, etc. The cameras may be integrated with individual animal recognition systems, akin to human facial recognition and gait recognition systems, or may cooperate with RFID tag systems or other tagging systems (e.g., optical detection of data on a conventional ear tag), thereby allowing observations of skin health, signs of injuries, etc., to be tracked over time for individual animals. Cameras and other sensors may be combined to give automated or semi-automated scoring of locomotion using any known locomotion index system.
Systems for analyzing bone location and characteristics, which may include x-ray systems, ultrasonic systems, fluorometers, tissue penetrating radar or microwave imaging systems, MRI, etc. A goal of hoof trimming in many cases is to align the horn of the external hoof with the interior bone, and such instrumentation could be helpful in guiding trimmers and assessing the quality of trimming. Results can be stored in databases for individual animals and may include tracking the work and efficiency of individual trimmers.
Gait sensors (particularly systems comprising cameras) that can monitor characteristics of an animal’s motion when walking, such as gait cycle duration, stance, swing phases, motion of individual legs, shoulder and back motion, etc., which may provide data about balance, distribution of weight, sensitivity of the hooves or legs or the presence of pain, mood or overall health, etc. Such data can be integrated with load distributions data from load cells, hoof imprints, and other means to enable analysis of the walking and standing characteristics of individuals animals in ways that relate to hoof health and leg health in order to guide trimmers and others in providing the optimum care.
Facial recognition systems and body recognition systems adapted for the animals of concern. For example, the state of a cow’s back may be indicative of the pain a cow faces, with a flat back being indicative of good health and a more arched back indicative of pain. Pain or other problems may also be reflected in facial characteristics. Interpretation of data may require machine learning systems or artificial intelligence that considers the broad variety of data pertaining to animals and their care in order to give recommendations to trimmers and other managers or care providers.
Accelerometers and related devices that can be mounted on animals to observe walking characteristics, or that may be mounted on floor panels to analyze step characteristics.
Step counting systems, including motion detectors, load cells, accelerometers, cameras, etc., to detect cow motion such as steps taken while standing on a platform, which can be a measure of pain.
Load cells and networks of load cells to form a weight distribution measurement platform or force and pressure platforms can be used to measure load distribution under the legs of the animal both while walking or while standing still, or to measure the load under a single hoof with relatively high spatial resolution.

Systems incorporating data from various sensors may employ decision-making systems to interpret data and give guidance to trimmers or other caregivers. For example, one or more sensors may obtain data for a given animal and may also obtain identity information from a tag or other means to identify the animal. The data is then processed by a processor using algorithms to determine if the animal, in light of the data, is facing health or pain issues that may require treatment by a trimmer. The processor interprets the data and may apply additional data from a database, such as historic information on the health of the animal to detect noteworthy changes, and the make a judgment about recommended treatment that may be needed or issues that should be checked by a trimmer. If the issues are serious, the animal may be culled ahead of the normally scheduled trim for immediate assistance in light of the issues identified based in the data, or, during the next scheduled trim, the recommendations for action based on the data may be communicated to the trimmer to guide proper care and maintenance in light of apparent problems that were detected. Results and recommendations can also be stored in a database for future tracking of animal characteristics and health to determine the efficacy of the trimmer’s work, etc., and to guide further future steps.

### REMARKS

When introducing elements of aspects of the invention or the embodiments thereof, the articles “a,” “an,” “the,” and “said” are intended to mean that there are one or more of the elements, and thus may include plural referents unless the context clearly dictates otherwise. The terms “comprising,” “including,” and “having” are intended to be inclusive and mean that there may be additional elements other than the listed elements.

Unless otherwise specified, all patents and patent applications mentioned herein should be understood to be hereby incorporated by reference to the extent they are non-contradictory herewith. Further, all aspects of any invention may be, when not clearly improper, combined with any other aspect, such that any limitation in one claim or other aspect can be inherently available for combination with other aspects and limitations.

Having described aspects of the invention in detail, it will be apparent that modifications and variations are possible without departing from the scope of aspects of the invention as defined in the appended claims. As various changes could be made in the above compositions, products, and methods without departing from the scope of aspects of the invention, it is intended that all matter contained in the above description shall be interpreted as illustrative and not in a limiting sense.

While the foregoing description makes reference to particular illustrative embodiments, these examples should not be construed as limitations. The inventive system, methods, and products can be adapted for other uses or provided in other forms not explicitly listed above, and can be modified in numerous ways within the spirit of the present disclosure. Thus, the present invention is not limited to the disclosed embodiments, but is to be accorded the widest scope consistent with the claims below.

We claim:

1. A grasper for hoof trimming of an animal comprising a knee board, a movable upper stage comprising a broad clamping surface and a movable lower stage comprising a relatively more narrow clamping surface, the upper stage and the lower stage both adapted to cooperate with the knee board to secure the lower leg of the animal.

2. The grasper of claim 1, further comprising at least one belt associated with the upper stage for securing the upper stage against the lower leg.

3. The grasper of claim 2, wherein the upper stage comprises at least one loop associated with the broad clamping for receiving the at least one belt.

4. The grasper of claim 1, wherein the ratio of the maximum width of the movable clamping surface of the upper stage to the maximum width of the movable clamping surface of the lower stage is from 1.2:1 to 30:1.

5. The grasper of claim 1 wherein the clamping length of the upper stage is at least 3 inches.

6. The grasper of claim 1 wherein the clamping length of the upper stage is from 4 inches to 14 inches.

7. The grasper of claim 1, wherein the broad clamping surface is at least 50% wider than the relatively more narrow clamping surface and is rotatably attached to a pivot.

8. The grasper of claim 1 wherein at least one of the knee board, the upper stage and the lower stage is associated with a sensor selected from a load cell, an accelerometer, a strain gauge, a position sensor, and a cardiovascular sensor.

9. The grasper of claim 1, further comprising a sensor associated with at least one of the lower stage, the upper stage, and the knee board, the sensor being selected from a load cell, an accelerometer, a motion detector, a strain gauge, a position detector, and a cardiovascular sensor.

10. The grasper of claim 1, further comprising an ultrasonic head for measuring characteristics of the animal.

11. The grasper of claim 10, further associated with a processor and a database to store information obtained from the ultrasonic head, wherein the processor generates one or more values based on the information obtained from the ultrasonic head and the one or more values are stored in the database and associated with the animal.

12. A chute for receiving animals for treatment of the lower legs or hooves of animals while in the chute, comprising a frame, a front gate attached to the frame, a belly band for supporting the animal and connected to a lifting system attached to the frame, and a grasper attached to the frame via a rotatable linkage, the grasper comprising a knee board, a movable upper stage comprising a broad clamping surface and a movable lower stage comprising a relatively more narrow clamping surface, the upper stage and the lower stage both adapted to cooperate with the knee board to secure the lower leg of the animal when they are in a closed position.

13. The chute of claim 12, wherein the broad clamping surface and the relatively more narrow clamping surface are both independently movable between an open position and a closed position, further comprising a first and second control systems to respectively control a force applied to the broad clamping surface and a force applied to the relatively more narrow clamping surface.

14. The chute of claim 12, further comprising a trimmer guidance system in communication with one or more sensors and a processor that are adapted to receive and analyze data relevant to animal health from the one or more sensors, and adapted to make a recommendation for action to be taken by the animal trimmer responsive to the data relevant to animal health.

15. The chute of claim 13, wherein the data relevant to animal health from one or more sensors comprise ultrasonic imaging data, gait analysis data, weight distribution data, step count data, indications of animal pain or adverse health conditions derived from analysis of at least one of photographs, video, animal sound recordings, measurements of animal motion, and measurements of the animal’s physiological state.

16. A method for hoof trimming, comprising guiding an animal into a chute, the chute comprising a belly band for supporting the animal, and at least one movable grasper for securing the lower leg of an animal, the grasper comprising a kneeboard, a movable upper stage, and a movable lower stage, wherein after the animal enters the chute, the grasper is moved into a position to grasp the lower leg of the animal by placing the leg between the knee board and both the upper stage and lower stage, then clamping the upper stage and the lower stage onto the lower leg of the animal, wherein a clamping surface of the upper stage contacts the lower leg along a contact length extending along the lower leg that is substantially greater than the contact length of the lower stage in the same direction, followed by rotating the grasper to bend the lower leg of the animal about the knee of the leg to bring the hoof into a position suitable for hoof trimming, followed by a hoof trimmer trimming the hoof.

17. The method of claim 16, wherein in response to a need for expanded access to the hoof or lower leg of the animal for treatment, expanded access is provided by releasing the lower stage without losing a secure grip on the lower leg of the animal provided by the upper stage.

18. The method of claim 16, wherein the rotation of the grasper is adjusted by one of hydraulics, pneumatics, or electric devices, and closing or opening of the upper stage is driven by one of hydraulics, pneumatics, or electric devices.

19. The method of claim 16, further comprising electronically providing a message to the hoof trimmer to guide the hoof trimmer on special needs of the animal, the message being generated by a processor in response to data acquired regarding animal health by one or more sensors or detection systems.

20. The method of claim 16, wherein the chute is provided with one or more sensors for assessing the health or behavior of the animal, and wherein data from the one or more sensors is stored in a database, the one or more sensors being selected from cameras, ultrasonic measurement systems, microphones, load cells, strain gauges, accelerometers, facial recognition systems, biometric identification systems, cardiovascular sensors, and gait analyzers.
